(19) United States
(12) Patent Application Publication
(10) Pub. No.: US 2017/0258120 A1
(43) Pub. Date: Sep. 14, 2017

(54) LIQUID SWEETENER COMPOSITIONS

(71) Applicant: Merisant US, Inc., Chicago, IL (US)

(72) Inventors: Jim George FOTOS, Willowbrook, IL (US); Matthieu PILVIN, Peseux (CH); Vukasin LEVAKOV, Chicago, IL (US); David Joseph SITKO, Chicago, IL (US)

(21) Appl. No.: 15/453,273

(22) Filed: Mar. 8, 2017

Related U.S. Application Data
(60) Provisional application No. 62/305,803, filed on Mar. 9, 2016.

(51) Int. Cl. A23L 27/30; A23L 27/10

(52) U.S. Cl. CPC A23L 27/36; A23L 27/10; A23V 2002/00

(57) ABSTRACT

Disclosed are methods of making a sweetener composition of high intensity sweetener and syrup.

### CROSS-REFERENCE TO RELATED APPLICATIONS

This application claims priority to U.S. Provisional Application No. 62/305,803, filed Mar. 9, 2016, the disclosure of which is hereby incorporated by reference in its entirety.

### BACKGROUND OF THE INVENTION

Field of the Invention

The disclosure provides methods of making a sweetener composition of one or more high intensity sweeteners and syrup.

Description of Related Art

The species Stevia rebaudiana (“Stevia”) has been the subject of considerable research and development efforts directed at the purification of certain naturally occurring sweet glycosides of Stevia that have potential as non-caloric sweeteners. Sweet glycosides that may be extracted from Stevia include all reported rebaudiosides (i.e., rebaudiosides A, B, C, D, E, and F, M, N and O), as well as stevioside, and the dulcosides, e.g., dulcosides A and B.

Non caloric or low caloric sweeteners can be delivered to consumers through solid or liquid applications. For example, packets of dry sweeteners are commonly used for sweetening coffee or other consumable products by sprinkling the contents of the packages over such products.

Non caloric or low caloric sweeteners can also be delivered in liquid form. For example, reduced calorie forms of honey and agave are desirable and can be delivered to consumers in conventional glass or plastic containers. Liquid sweeteners also have utility as a means of delivering sweetness to other food and beverage products.

Thus, there is an interest in improving natural and other syrups so that they have less calories or so that a reduced amount of the sweetener may be used without sacrificing taste. The caloric content of natural and other syrups may be reduced by decreasing the solids content of the syrup, which in turn reduces the caloric content. Because all of the solids are often removed, gums have been added to create texture, and natural or artificial flavors have been added to create or enhance the flavor. Syrups made in this manner have many undesirable attributes. For example, these gum based low calorie syrups have an unnatural mouth feel (e.g., they are slimy, gummy, or thin), minimal aroma, and do not taste like natural syrups. In turn, high intensity sweeteners have been used to adjust the sweetness of the syrup. However, the resulting products lack certain desirable characteristics of the natural syrups. For example, rebaudiosides, such as rebaudiosides A, B, C, D, E, F, M, N and O, stevioside, and dulcosides A and B sometimes cannot be dissolved in a syrup, and when these high intensity sweeteners are used to prepare modified syrup compositions, the resulting modified syrup compositions become cloudy after prolonged storage, a characteristic which is not expected by or appealing to consumers. Sweetener products typically are located on grocery or mass merchandiser shelves where shelf life of at least 1 to 2 years is typically expected. The visual and microbial stability of such products is thus crucial.

Further, some liquid sweetener compositions that contain, for example, steviol glycosides, include ingredients which may not be desired in certain applications, such as preservatives. Some non-desirable ingredients, such as propylene glycol glycerol or vegetable glycerin may be added to control water activity to avoid the use of preservatives, if water is needed to solubilize the stevia component. Artificial or natural preservatives may be used to control microbiological activity. These components are becoming undesirable for use in many food and beverage products as consumers are increasingly looking for such products with limited or no additives.

### SUMMARY OF THE INVENTION

In a broad aspect, the disclosure provides improved methods for preparation of sweetener compositions, particularly liquid sweetener compositions. For example, in certain aspects, the methods of the disclosure provide sweetener compositions with improved appearance, taste and without the use of preservatives. In particular, the sweetener compositions prepared by the methods of the disclosure are clear and homogeneous appearance after production and typically continue to be solutions after several months if not years. For example, the methods of the disclosure allow for high intensity sweetener component (e.g., rebaudiosides A, B, C, D, E, F, M, N and O, stevioside, and dulcosides A and B) to remain in syrup for a long period of time without becoming cloudy (e.g., without the sweetening component crystallizing out of the solution) making the sweetener compositions more appealing to consumers. In addition, the high intensity sweetener component provides additional sweetness to the sweetener compositions, making it further appealing to the consumers.

Thus, one aspect of the disclosure provides a method of making a sweetener composition, the method comprising:
(a) providing an aqueous solution of high intensity sweetener having a temperature of about 60° C. to about 95° C., and
(b) adding the aqueous solution of high intensity sweetener to a syrup.

In a further aspect, the disclosure provides clear sweetener compositions prepared by the methods of the disclosure.

In a further aspect, the disclosure provides stable, clear sweetener compositions consisting essentially of one or more steviol glycoside components such as rebaudiosides, about 0.01% to about 2%, or about 0.10% to about 0.50% by weight of one or more of rebaudioside components, and water. The compositions are stable and clear for an extended period of time.

In another aspect, the liquid sweeteners made by the process disclosed herein may be provided or, for example, sold as the liquid sweetener alone. In addition, in another aspect, these liquid sweetener compositions may be incorporated into other food products to adjust the sweetness of those food products. Such food products typically have low water contents (<40% by weight) and are generally liquids or syrups, but also can be in substantially a paste form. The solids content in such food products is primarily carbohydrate, fat, protein, or combinations thereof. Examples of such products include yogurt, jelly, jam, fruit fillings for pies, nutrition bars, icings, mayonnaise, ketchup, confectionary and compound coatings.

### DETAILED DESCRIPTION OF THE INVENTION

Before the disclosed materials and methods are described, it is to be understood that the aspects described herein are not limited to specific embodiments, or configurations, and as such can, of course, vary. It is also to be understood that the terminology used herein is for the purpose of describing particular aspects only and, unless specifically defined herein, is not intended to be limiting.

In view of the present disclosure, the methods and active materials described herein can be configured by the person of ordinary skill in the art to meet the desired need. In general, the disclosed methods and materials provide improvements in preparation of sweetener compositions. For example, in certain aspect, the methods of the disclosure provide sweetener compositions with improved appearance and taste. In particular, the sweetener compositions prepared by the methods of the disclosure have clear and homogeneous appearance after several days, even weeks or years. For example, the methods of the disclosure allow for high intensity sweetener component (e.g., rebaudioside A, B, C, D, E, F, M, N, or O, stevioside, or dulcoside A or B) to remain in the syrup for a long period of time without becoming cloudy (e.g., without the high intensity sweetener crystallizing out of the solution) making the sweetener compositions more appealing to consumers and in compliance with shelf life requirements. In addition, the high intensity sweetener component provides additional sweetness to the sweetener compositions, making it further appealing to the consumers.

Further, not only do the liquid sweetener compositions produced according to the process disclosed herein remain clear for lengthy periods of time, these compositions do not require the use of preservatives to prevent microbial growth and contamination.

As used herein, the term “clear” means free of undissolved high intensity sweetener material, e.g., steviol glycosides, in particular, rebaudiosides. For example, the compositions of the disclosure are homogenous showing a complete mixing of the aqueous solution of high intensity sweetener with a syrup and no interface between aqueous solution and the syrup.

One aspect of the disclosure provides a method of making a sweetener composition, the method comprising:
(a) providing an aqueous solution of high intensity sweetener having a temperature of about 60° C. to about 95° C., and
(b) adding the aqueous solution of high intensity sweetener to a syrup.

As used herein, the term “high intensity sweetener” means a substance that provides a high sweetness per unit mass (e.g., as measured in accordance with the test method described in GB Patent No. 1,543,167) compared to a nutritive sweetener (such as sucrose), and provides little or no nutritive value. Some high intensity sweeteners, such as, aspartame, are nutritive, but are so intense that they still provide negligible calories because very small amounts are required. Other high intensity sweeteners, such as, for example, sucralose, are not absorbed when ingested and are, therefore, non-nutritive sweeteners. Many high intensity sweeteners are known to those skilled in the art and any may be used in the present invention. Examples of high intensity sweeteners useful in the present disclosure include, but are not limited to, aspartame, acesulfame, alitame, brazzein, cyclamic acid, dihydrochalcones, extracts of Stevia rebaudiana Bertoni plant (e.g., rebaudiosides A, B, C, D, E, F, M, N, and O, stevioside, and dulcosides A and B), extracts of Dioscoreophyllum cumminsii, extracts of the fruit of Pentadiplandra brazzeana, glycyrrhizin, hernandulcin, monellin, monatin, monk fruit extracts including but not limited to mogrosides, neotame, neohesperidin, saccharin, sucralose, thaumatin, and combinations thereof. The high intensity sweeteners include known and unique steviol glycosides and other sweeteners made by fermentation, enzymatic or synthetic processes.

Particular high intensity sweeteners for use in the methods disclosed herein may comprise a blend of two or more individual high intensity sweeteners. Examples of such blends are (i) monk fruit extracts and steviol glycosides, (ii) aspartame and steviol glycosides, and (iii) steviol glycosides and sucralose. Individual high intensity sweeteners may also be blended with a variety of sweeteners having lesser sweetness intensity, such as sugars and sugar alcohols such as erythritol, maltitol, mannitol, and xylitol.

By an extract or extracts of Stevia rebaudiana Bertoni plant is meant a glycoside or a blend of glycosides isolated from the plant. These extracts can be up to 300 times sweeter than sucrose. Glycosides of particular interest for their high level of sweetness and/or low level of bitterness include steviol glycosides or rebaudiosides, such as rebaudioside A, rebaudioside B, rebaudioside C, rebaudioside D, rebaudioside E, rebaudioside F, rebaudioside M, rebaudioside N, and rebaudioside O, other steviol glycosides, stevioside, dulcoside A, dulcoside B, and mixtures thereof. It can be a challenge, however, to maintain one of these (or a blend of these) glycosides at a relatively high concentration in solution for a long period of time. The present disclosure provides methods that make sweetener compositions that have clear and homogeneous appearance after several days, even weeks, months or years.

In one embodiment of the disclosure, the high intensity sweetener is a blend of steviol glycosides, including one or more rebaudiosides.

For example, in one embodiment, the high intensity sweetener is rebaudioside A. Some embodiments of the present disclosure comprise the high intensity sweetener component which includes a large percentage (e.g., more than 50%, or 60%, or 70%, or 75%, or 80%, or 85%, or 90%, or 95%, or 99% by weight of the high intensity sweetener) of rebaudioside A. Other embodiments comprise the high intensity sweetener component which includes a large percentage of a blend of rebaudioside A and other rebaudiosides or glycosides.

In another embodiment, the rebaudioside A purity is greater than 70%, or 75%, or 80%, or 85%, or 90%, or 95% by weight. In another embodiment, rebaudioside A purity is greater than 97% by weight.

As a further example, the high intensity sweetener is rebaudioside B or rebaudioside D. Some embodiments of the present disclosure comprise the high intensity sweetener component which includes a large percentage (e.g., more than 50%, or 60%, or 70%, or 75%, or 80%, or 85%, or 90%, or 95%, or 99% by weight of the high intensity sweetener) of rebaudioside B. Other embodiments comprise the high intensity sweetener component which includes a large percentage (e.g., more than 50%, or 60%, or 70%, or 75%, or 80%, or 85%, or 90%, or 95%, or 99% by weight of the high intensity sweetener) of rebaudioside D. Yet other embodiments comprise the high intensity sweetener component which includes a large percentage of a blend of rebaudioside B and rebaudioside D.

Similarly, liquid sweetener compositions made as disclosed herein may be made using other steviol glycosides, e.g., rebaudioside C, rebaudioside E, rebaudioside F, rebaudioside M, rebaudioside N, rebaudioside O, stevioside, dulcoside A, and dulcoside B, or may be made with blends of such glycosides. Thus, in certain aspects of this disclosure, the high level of purity of a particular rebaudioside in the sweetener composition is not significant. Commercially available glycoside blends may also be used.

In one embodiment of the disclosure, the high intensity sweetener is present from about 0.1 wt % to about 2 wt % based on the weight of the sweetener composition. In other embodiments, the high intensity sweetener is present from about 0.1 wt % to about 1 wt %, or about 0.1 wt % to about 0.5 wt %, or about 0.2 wt % to about 0.3 wt %, based on the weight of the syrup composition. In certain embodiments, the high intensity sweetener is present from about 0.23 wt % to about 0.27 wt % based on the weight of the sweetener composition.

As used herein, the term “syrup” means a syrup having a high concentration, typically from about 60 to 85% by weight, of saccharide solids and the balance primarily water. Suitable syrups for use herein are made up primarily of a mixture of water and glucose, fructose, fructo oligosaccharide, galacto oligosaccharide, inulin, and various polysaccharides or oligoglucoses. Common examples of compositions which could function as the syrup component include invert sugar syrup, evaporated cane juice syrups (liquid cane syrups), corn syrup (with varying ratios of glucose to fructose), and natural syrups such as fruit syrups, tree syrups, bee syrups, tuber syrups, grass syrups, and mixtures thereof. An invert sugar syrup refers to glucose-fructose based syrup that results from the hydrolysis of sucrose into glucose and fructose. The syrups may include levels of solids such as particles of fruit.

In one embodiment, the syrup of the disclosure is selected from fruit syrups, tree syrups, bee syrups, tuber syrups, grass syrups, and mixtures thereof. In another embodiment, the syrup is selected from the group consisting of agave syrup, sugarcane syrup, honey, maple syrup, almond syrup, banana syrup, blueberry syrup, cherry syrup, coconut syrup, hazelnut syrup, kiwi syrup, lemon syrup, mango syrup, orange syrup, peach syrup, strawberry syrup, vanilla syrup, raspberry syrup, apple syrup, blackberry syrup, pineapple syrup, invert sugar syrup, molasses, and mixtures thereof. In another embodiment, the syrup is agave syrup, sugarcane syrup, honey, coconut syrup, maple syrup, and mixtures thereof. In certain embodiments, the syrup is agave syrup. In other certain embodiments, the syrup is honey.

In the methods of the disclosure, an aqueous solution of high intensity sweetener is provided. The aqueous solution comprises water and the high intensity sweetener in a ratio of about 1:1 to about 20:1. In one embodiment, the ratio of water and the high intensity sweetener is about 2:1 to about 20:1, or about 3:1 to about 20:1, or about 5:1 to about 20:1, or about 7:1 to about 20:1, or about 10:1 to about 20:1, or about 2:1 to about 10:1, or about 3:1 to about 10:1, or about 5:1 to about 10:1, or about 7:1 to about 10:1, or about 1:1 to about 7:1, or about 2:1 to about 7:1, or about 5:1 to about 7:1, or about 2:1 to about 5:1, or about 3:1 to about 5:1. In one embodiment, the ratio of water and the high intensity sweetener is about 2:1, or about 3:1, or about 4:1, or about 5:1, or about 10:1.

In the methods of the disclosure, the aqueous solution of high intensity sweetener is produced by heating water to, for example, its boiling point, allowing the water to cool to a predetermined, but still-elevated temperature, and then adding the high intensity sweetener to the water. Alternatively, the water may be heated to the temperature at which the high intensity sweetener is to be added, and then the sweetener is added. The temperature at which the solid sweetener is added ranges from about 60° C. to about 95° C. In certain embodiments, the temperature of the water to which the high intensity sweetener is added is about 50° C. to about 90° C., or about 50° C. to about 90° C., or about 50° C. to about 80° C., or about 50° C. to about 70° C., or about 60° C. to about 90° C., or about 60° C. to about 85° C., or about 60° C. to about 80° C., or about 60° C. to about 75° C., or about 50° C. to about 60° C. In one embodiment of the methods of the disclosure, the water is at a temperature of about 75° C. to about 85° C. In another embodiment of the methods of the disclosure, the water is at a temperature of about 50° C. to about 60° C. In some embodiments, the temperature at which the solid sweetener is added at about 100° C.

Subsequently, the aqueous solution of the high intensity sweetener is added at the elevated temperature to the syrup and the resulting mixture blended until homogenous.

The methods of the disclosure may be performed wherein adding in (b) is a gradual addition with continuous stirring. Such stirring may be sufficient to obtain a homogeneous solution of the sweetener composition. For example, the stirring speed and duration may be adjusted to provide a homogeneous solution of the sweetener composition.

The compositions made using the process disclosed herein are clear, stable sweetener compositions consisting essentially of one or more steviol glycoside components such as, for example, rebaudiosides A, B, C, D, E, F, M, N and O, stevioside, and dulcosides A and B, about 60-90% by weight of one or more saccharides, and water. The compositions are stable and clear for an extended period of time. More specifically, the sweetener compositions remain clear and microbe-free for extended periods of time (e.g., more than 30 days, more than 60 days, or even more than 90 days) after the composition has been prepared. Significantly, the clarity and stability of the disclosed compositions is achieved without the addition of stabilizers, e.g., antimicrobial agents, antioxidants, or solvents, such as ethanol or propylene glycol. As a consequence, the compositions disclosed herein are preferably free of such materials.

Thus, the methods of the disclosure provide the sweetener composition is substantially free of other additives. As used herein the term “substantially free of,” with respect to a particular ingredients, refers to the particular ingredient being present in a concentration less than is necessary for the ingredient to be effective to provide the benefit or property for which it otherwise would be used, for example, about 0.5 wt % or less, or about 0.1 wt % or less, or about 0.05 wt % or less (based on the total weight of the sweetener composition).

In a further aspect, the disclosure provides a clear sweetener composition prepared by the methods of the disclosure.

In a further aspect, the disclosure provides a clear sweetener composition consisting essentially of a rebaudioside (e.g. rebaudioside A, B, C, D, E, F, M, N or O, stevioside, or dulcosides A or B, or mixtures thereof), about 60-90% by weight of one or more saccharides, and water, where the composition is clear for more than 30 days.

### Definitions

The following terms and expressions used have the indicated meanings.

Throughout this specification, unless the context requires otherwise, the word “comprise” and “include” and variations (e.g., “comprises,” “comprising,” “includes,” “including”) will be understood to imply the inclusion of a stated component, feature, element, or step or group of components, features, elements or steps but not the exclusion of any other integer or step or group of integers or steps.

As used in the specification and the appended claims, the singular forms “a,” “an,” and “the” include plural referents unless the context clearly dictates otherwise.

As used herein, the term “about” refers to the given value±10% of the value.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

All percentages, ratios and proportions herein are by weight, unless otherwise specified. A weight percent (weight %, also as wt %) of a component, unless specifically stated to the contrary, is based on the total weight of the composition in which the component is included (e.g., on the total amount of the compositions). All mol% values are based on the moles of the active compounds, unless otherwise noted.

### EXAMPLES

The methods of the disclosure are illustrated further by the following examples, which are not to be construed as limiting the disclosure in scope or spirit to the specific procedures and in them.

### Example 1

### Preparation of Composition with Reb A:Water (1:10) Mixture

Materials:

Light agave syrup: 75 kg (87.62%)

Dark agave syrup: 8.3 kg (9.70%)

Water at 80° C.: 2.09 kg (2.44%)

Reb A (97% pure): 0.209 kg (0.24%)

Total weight: 85.599 kg

Blending Procedure:

Water was boiled and weighted in a beaker. Reb A was added into the water at 80° C. and stirred manually. Light and dark agave syrups were blended together for 1 min, and to this blend the hot water-Reb A solution was added. All blending was done on agitation setting one. Total blending time of syrup with Reb A was 15 minutes.

Observations:

At this agitation, it was observed that the blend did not begin within the first 2 minutes. After a few minutes of blending, foam on the wall of the tank was observed. After about 8 and 10 minutes of blending, the foam disappeared.

### Example 2

### Preparation of Composition with Reb A:Water (1:4) Mixture

Materials:

Light agave syrup: 75 kg (87.62%)

Dark agave syrup: 8.3 kg (9.70%)

Water at 80° C.: 0.874 kg (1.02%)

Reb A (97% pure): 0.209 kg (0.24%)

Total weight: 84.383 kg

Blending Procedure:

One half of water amount was boiled and cooled to 80° C. Reb A was added into the water at 80° C. water and stirred manually first. Reb A was then dispersed into water with a high shear hand mixer. The temperature dropped down under 70° C. and no satisfying dispersion/dissolution could be reached at 2:1 water:Reb A ratio. Then, the remaining half of water (hot) was added to the water-Reb A solution to reach temperature of 71° C. and a clear solution was observed. Light and dark agave syrups were blended together for 1 min, and to this blend the hot water-Reb A solution was added. All blending was done on agitation setting one. Total blending time of syrup with Reb A was 15 minutes. At the completion of mixing, the final temperature of the mixture was 13.8° C.

Analysis:

Reb A content analysis was done by HPLC, and the results are shown in Table 1.

TABLE 1
HPLC Analysis of Reb A content

| | |
|---|---|
| First blend | Second blend |

| Blending time | Reb A | RSD (%) | Reb A | RSD (%) |
|---|---|---|---|---|
| 4 min | 0.289 | 13.42 | 0.2456 | 0.99 |
| 4 min | 0.2694 | | 0.2477 | |
| 4 min | 0.272 | | 0.2422 | |
| 4 min | 0.2169 | | 0.2419 | |
| 4 min | 0.3171 | | 0.2447 | |
| 6 min | 0.2234 | 3.19 | 0.246 | 1.33 |
| 6 min | 0.2425 | | 0.242 | |
| 6 min | 0.2351 | | 0.2469 | |
| 6 min | 0.241 | | 0.2456 | |
| 6 min | 0.2361 | | 0.2392 | |
| 8 min | 0.2538 | 6.23 | 0.2422 | 1.05 |
| 8 min | 0.2366 | | 0.2354 | |
| 8 min | 0.2684 | | 0.2403 | |
| 8 min | 0.239 | | 0.2385 | |
| 8 min | 0.2306 | | 0.2391 | |
| 15 min | 0.2259 | 1.26 | 0.2411 | 1.48 |
| 15 min | 0.2305 | | 0.2448 | |
| 15 min | 0.2325 | | 0.2451 | |
| 15 min | 0.226 | | 0.2363 | |
| 15 min | 0.2295 | | 0.2413 | |

Based on Reb A content analysis, with this blending tool and agitation speed, about 6 to 8 minutes is needed to get a homogenous blend. Temperature check of blend shows that there is no need to heat up the syrup because homogeneity was observed in a couple of minutes at 14° C. In addition, the water-Reb A ratio does not impact either the homogeneity of the blend or the blending time.

### Example 3

Water (5.4 kg) was heated to boiling and cooled to 80° C. Powder Reb A (97% purity, 0.54 kg) was then added. Water with Reb A was stirred until Reb A powder was completely dissolved. Syrup (215.4 kg) was gently stirred, and to the stirred syrup hot water-Reb A mixture was added. The mixture was then blended for at least for 15 minutes, and the mixing was stopped based on visual inspection for homogeneous mixture.

The mixture was then cooled and stored in non-controlled temperature storage to evaluate stability of syrup under variable temperature conditions. Reb A content, color, density at ambient temperature, and microbiology were evaluated and the results are provided in Table 2.

TABLE 2

| | Agave Stevia blend | | | | |
|---|---|---|---|---|---|
| | blend 15 min | | blend 25 min | | Aver- |
| | A | B | A | B | age |
| Moisture (%) | 25.83 | 26.22 | 25.92 | 26.03 | 26.0 |
| water | 0.680 | 0.690 | 0.684 | 0.675 | 0.682 |
| activity | | | | | |
| density at | 1400 | 1400 | 1382 | 1390 | 1393 |
| ambient | | | | | |
| temperature | | | | | |
| (g/L) | | | | | |
| RebA | 0.252 | 0.253 | 0.249 | 0.254 | 0.25 |
| content | | | | | |
| (w/w) | | | | | |

Raw material

| Microbiology | Product | Dark syrup | Light syrup |
|---|---|---|---|
| Total aerobic | <10 | 80 | 10 |
| count (ufc/g) | | | |
| Mold (ufc/g) | 20 | 10 | <10 |
| Yeast (ufc/g) | <10 | <10 | <10 |

### Example 4

Water (5.4 kg) was heated up to boiling, then cooled to between 50-60° C., and powder Reb A (97% purity, 0.54 kg) was added. Water with Reb A was stirred until Reb A powder was completely dissolved. Agave syrup (215.4 kg) was gently stirred, and to the stirred syrup hot water-Reb A mixture was added. The mixture was then blended for at least for 15 minutes, and the mixing was stopped based on visual inspection for homogeneous mixture.

### Example 5

### Long-Term Studies

The composition of Example 4 was tested for long-term stability. Reb A content was analyzed by previously established HPLC methods. The compositions were tested under 4 storage conditions:
Real Time Temperature and Humidity: 25±2° C., 60±5% RH
Accelerated Temperature and Humidity: 30±2° C., 65±5% RH
Accelerated Temperature and Humidity: 35±2° C., 80±5% RH
Accelerated & Stressed Temperature and Humidity: 40±2° C., 75±5% RH
   Samples under Accelerated & Stressed (40° C., 75% RH) conditions were tested at weeks 0, 2, 4, 6, 8, 13, and 26. Samples under Accelerated conditions (35° C., 80% RH) were tested at weeks 0, 4, 8, 13, 26, and 52. Representative results are shown in Tables 3-6.

TABLE 3
Stability results at 25 ± 2° C. and 60 ± 5% RH

| Test | Initial | 13 week |
|---|---|---|
| Reb A | 0.23 | 0.23 |
| Appearance | free flowing | free flowing |
| | brown liquid | brown liquid |
| Color | dark brown | dark brown |
| Color - Y-Index | 58.08 | 69.51 |
| pH | 4.58 | 4.71 |

TABLE 4
Stability results at 30 ± 2° C. and 65 ± 5% RH

| Test | Initial | 8 weeks | 13 weeks |
|---|---|---|---|
| Reb A | 0.23 | 0.26 | 0.24 |
| Appearance | free flowing | free flowing | free flowing |
| | brown liquid | brown liquid | brown liquid |
| Color | dark brown | dark brown | dark brown |
| Color - Y-Index | 58.08 | 49.49 | 69.32 |
| pH | 4.58 | 4.53 | 4.87 |
| Aerobic Plate Count | 18 CFU/g | | 18 CFU/g |
| Total Coliforms | <10 CFU/g | — | <10 CFU/g |
| Escherichia coli | <10 CFU/g | — | <10 CFU/g |
| Salmonella | 0 CFU/g | — | 0 CFU/g |
| Yeast | <3 CFU/g | — | <3 CFU/g |
| Mold | <3 CFU/g | — | <3 CFU/g |

TABLE 5
Stability results at 35 ± 2° C. and 80 ± 5% RH

| Test | Initial | 4 weeks | 8 weeks | 13 weeks |
|---|---|---|---|---|
| Reb A | 0.23 | 0.27 | 0.25 | 0.22 |
| Appearance | free flowing | free flowing | free flowing | free flowing |
| | brown liquid | brown liquid | brown liquid | brown liquid |
| Color | dark brown | brown | dark brown | dark brown |
| Color - | 58.08 | 54.16 | 57.91 | 65.59 |
| Y-Index | | | | |
| pH | 4.58 | 4.55 | 4.44 | 4.70 |
| Aerobic Plate | 18 CFU/g | | 15 CFU/g | 12 CFU/g |
| Count | | | | |
| Total | <10 CFU/g | — | <10 CFU/g | <10 CFU/g |
| Coliforms | | | | |
| Escherichia | <10 CFU/g | — | <10 CFU/g | <10 CFU/g |
| coli | | | | |
| Salmonella | 0 CFU/g | — | 0 CFU/g | 0 CFU/g |
| Yeast | <3 CFU/g | — | <3 CFU/g | <3 CFU/g |
| Mold | <3 CFU/g | — | <3 CFU/g | <3 CFU/g |

TABLE 6
Stability results at 40 ± 2° C. and 75 ± 5% RH

| Test | Initial | 2 week | 4 weeks | 6 weeks | 8 week | 13 weeks |
|---|---|---|---|---|---|---|
| Reb A | 0.23 | 0.25 | 0.27 | 0.27 | 0.26 | 0.22 |
| Appearance | free | free | free | free | free | free |
| | flowing | flowing | flowing | flowing | flowing | flowing |
| | brown | brown | brown | brown | brown | brown |
| | liquid | liquid | liquid | liquid | liquid | liquid |
| Color | dark | dark | dark | dark | dark | dark |
| | brown | brown | brown | brown | brown | brown |
| Color-Y- | 58.08 | 63.08 | 69.48 | 66.36 | 63.19 | 70.34 |
| Index | | | | | | |
| pH | 4.58 | 4.54 | 4.42 | 4.39 | 4.43 | 4.61 |
| Aerobic | 18 CFU/g | | 24 CFU/g | 18 CFU/g | 15 CFU/g | 3 CFU/g |
| Plate Count | | | | | | |
| Total | <10 CFU/g | — | <10 CFU/g | <10 CFU/g | <10 CFU/g | <10 CFU/g |
| Coliforms | | | | | | |
| Escherichia | <10 CFU/g | — | <10 CFU/g | <10 CFU/g | <10 CFU/g | <10 CFU/g |
| coli | | | | | | |
| Salmonella | 0 CFU/g | — | 0 CFU/g | 0 CFU/g | 0 CFU/g | 0 CFU/g |
| Yeast | <3 CFU/g | — | <3 CFU/g | <3 CFU/g | <3 CFU/g | <3 CFU/g |
| Mold | <3 CFU/g | — | <3 CFU/g | <3 CFU/g | <3 CFU/g | <3 CFU/g |

Compositions of the disclosure were found to be stable, homogeneous and clear after prolonged storage. In addition, the compositions of the disclosure were found to be free of microbial growth and contamination. Finally, these values support 2 year accelerated shelf-life for the compositions of the disclosure.

It is understood that the examples and embodiments described herein are for illustrative purposes only and that various modifications or changes in light thereof will be suggested to persons skilled in the art and are to be incorporated within the spirit and purview of this application and scope of the appended claims. All publications, patents, and patent applications cited herein are hereby incorporated herein by reference for all purposes.

We claim:

1. A method of making a sweetener composition, the method comprising:
(a) providing an aqueous solution of high intensity sweetener having a temperature of about 50° C. to about 95° C., and
(b) adding the aqueous solution of high intensity sweetener to a syrup.

2. The method of claim 1, wherein water and the high intensity sweetener in the aqueous solution of high intensity sweetener are in a weight ratio of about 2:1 to about 10:1.

3. The method of claim 1, wherein water and the high intensity sweetener in the aqueous solution of high intensity sweetener are in a weight ratio of about 3:1 to about 5:1.

4. The method of claim 1, wherein water and the high intensity sweetener in the aqueous solution of high intensity sweetener are in a weight ratio of about 4:1.

5. The method of claim 1, wherein the aqueous solution of high intensity sweetener is at a temperature of about 50° C. to about 90° C.

6. The method of claim 5, wherein the aqueous solution of high intensity sweetener is at a temperature of about 75° C. to about 85° C.

7. The method of claim 5, wherein the aqueous solution of high intensity sweetener is at a temperature of about 50° C. to about 60° C.

8. The method claim 1, wherein adding in (b) is a gradual addition with continuous stirring.

9. The method claim 1, wherein adding in (b) is sufficient to obtain a homogeneous solution of the sweetener composition.

10. The method of claim 9, wherein the high intensity sweetener is a steviol glycoside.

11. The method of claim 9, wherein the high intensity sweetener is rebaudioside A, rebaudioside B, rebaudioside C, rebaudioside D, rebaudioside E, rebaudioside F, rebaudioside M, rebaudioside N, rebaudioside O, or a mixture thereof.

12. The method of claim 1, wherein the high intensity sweetener is present from about 0.1 wt % to about 2 wt % based on the weight of the sweetener composition.

13. The method claim 10, wherein the syrup is selected from the group consisting of fruit syrups, tree syrups, bee syrups, tuber syrups, grass syrups, and mixtures thereof.

14. The method claim 13, wherein the syrup is agave syrup, sugarcane syrup, honey, coconut syrup, maple syrup, and mixtures thereof.

15. The method of claim 13, wherein the syrup is agave syrup.

16. The method of claim 13, wherein the syrup is honey.

17. The method of claim 13, wherein the sweetener composition is substantially free of other additives.

18. The method of claim 13, wherein the sweetener composition is homogeneous and clear.

19. A sweetener composition consisting essentially of a steviol glycoside, about 60-90% by weight of one or more saccharides, and water, where the composition retains shelf stability for more than 13 weeks accelerated conditions.

20. A sweetener composition consisting essentially of a steviol glycoside, about 60-90% by weight of one or more saccharides, and water, where the composition remains free of undissolved rebaudiosides for more than a year.
